(19) United States
(12) Patent Application Publication
(10) Pub. No.: US 2024/0331899 A1
(43) Pub. Date: Oct. 3, 2024

(54) R-T-B BASED PERMANENT MAGNET

(71) Applicant: TDK CORPORATION, Tokyo (JP)

(72) Inventors: Ikuya KOKAWA, Tokyo (JP); Yoshinori Fujikawa, Tokyo (JP); Takahiro Suwa, Tokyo (JP); Wakako Okawa, Tokyo (JP)

(73) Assignee: TDK CORPORATION, Tokyo (JP)

(21) Appl. No.: 18/607,699

(22) Filed: Mar. 18, 2024

(30) Foreign Application Priority Data
Mar. 31, 2023 (JP) 2023-058424
Nov. 28, 2023 (JP) 2023-200937

(51) Int. Cl. H01F 1/057; B22F 3/16; B22F 3/24; B22F 9/02; B22F 9/04; C22C 38/00; C22C 38/06; C22C 38/10; C22C 38/14; C22C 38/16

(52) U.S. Cl. CPC H01F 1/0577; B22F 3/16; B22F 3/24; B22F 9/023; B22F 9/04; C22C 38/002; C22C 38/005; C22C 38/06; C22C 38/10; C22C 38/14; C22C 38/16; B22F 2003/248; B22F 2009/044; B22F 2201/02; B22F 2201/20; B22F 2202/05; B22F 2301/355; B22F 2998/10; B22F 2999/00

(57) ABSTRACT

An R-T-B based permanent magnet comprises main phases each comprising a core and a shell, and a grain boundary phase adjacent to the main phases. The shell comprises Tb. The shell has a thickness of 70 nm or more. The shell has a Tb concentration with a maximum of 1.7 at % or more.

### TECHNICAL FIELD

The present invention relates to an R-T-B based permanent magnet.

### BACKGROUND

Patent Document 1 discloses an invention related to preparation of rare earth permanent magnet material. Patent Document 1 discloses that disposing a compound or the like of a rare earth element (in particular, Dy and/or Tb) on a surface of a sintered magnet form and heat treating them can provide a rare earth permanent magnet material having a high remanence (residual flux density) (Br) and a high coercive force (Hcj).
Patent Document 1: WO 2006/043348

### SUMMARY

It is an object of the present invention to provide an R-T-B based permanent magnet having a high residual magnetic flux density (Br), a high coercivity (Hcj), and a high squareness (Hk/Hcj).

To achieve the above object, an R-T-B based permanent magnet of the present invention comprises:
main phases each comprising a core and a shell; and
a grain boundary phase adjacent to the main phases,
wherein
the shell comprises Tb;
the shell has a thickness of 70 nm or more; and
the shell has a Tb concentration with a maximum of 1.7 at % or more.

The Tb concentration of the shell may gradually increase from a vicinity of the core to a vicinity of the grain boundary phase.

Provided that measurement points of the Tb concentration are determined inside the shell at 10-nm intervals from the core to the grain boundary phase,
the Tb concentration may be higher at the measurement points closer to the grain boundary phase; and
differences in the Tb concentration between all the measurement points next to each other may be 0.01 at % or more and 0.50 at % or less.

1.0≤[Tb_{b}]/[Tbₛ]≤1.5 may be satisfied, where [Tbₛ] is a maximum value of the Tb concentration of the shell and [Tb_{b}] is a maximum value of a Tb concentration of the grain boundary phase.

The R-T-B based permanent magnet may have a Tb content of 0.6 mass % or more and 2.1 mass % or less.

The R-T-B based permanent magnet may comprise Fe or both Fe and Co as a transition metal element.

The grain boundary phase may comprise at least one selected from Fe and Co; and the grain boundary phase may have a total concentration distribution of Fe and Co with a minimum of 65.0 at % or less.

The R-T-B based permanent magnet may have a squareness Hk/Hcj of 97.0% or more.

### BRIEF DESCRIPTION OF THE DRAWING(S)

FIG. 1 is a schematic view of main phases, a grain boundary phase, and their locational relationship to a line AB.

FIG. 2 is a graph of concentration variation of Tb on the line AB.

FIG. 3 is a graph of concentration variation of Cu on the line AB.

FIG. 4 is a graph of concentration variation of Fe and Co in total and concentration variation of Nd on the line AB.

FIG. 5 is a schematic view of a shape of a magnet of an example.

### DETAILED DESCRIPTION

Hereinafter, the present invention is described based on a specific embodiment.

### <R-T-B Based Permanent Magnet>

An R-T-B based permanent magnet according to the present embodiment includes main phase grains including crystal grains having an R₂T₁₄B type crystal structure. The R-T-B based permanent magnet further includes grain boundaries between two or more adjacent main phase grains.

In the R-T-B based permanent magnet and the R₂T₁₄B type crystal structure, “R” represents at least one rare earth element, “T” represents at least one transition metal element, and “B” represents boron.

At least one rare earth element contained as “R” in the R-T-B based permanent magnet and the R₂T₁₄B type crystal structure may include Sc, Y, and lanthanoid. At least one transition metal element contained as “T” does not include rare earth elements. The at least one transition metal element contained as “T” may include at least one iron group element. The at least one iron group element contained as “T” may include at least one selected from Fe and Co. The at least one iron group element contained as “T” may include Fe or may include Fe and Co. Boron contained as “B” may be partly substituted by carbon.

In the present embodiment, rare earth elements are classified into heavy rare earth elements and light rare earth elements. Heavy rare earth elements include Gd, Tb, Dy, Ho, Er, Tm, Yb, and Lu. Light rare earth elements include rare earth elements other than heavy rare earth elements. Iron group elements include Fe, Co, and Ni.

A magnet composition of the R-T-B based permanent magnet according to the present embodiment is described below. Any method of measuring the R-T-B based permanent magnet may be used. For example, XRF can be used.

The rare earth element content (“R” content) of the R-T-B based permanent magnet is not limited. The rare earth element content may be 25.0 mass % or more and 35.0 mass % or less, 29.0 mass % or more and 33.0 mass % or less, or 30.0 mass % or more and 32.0 mass % or less. When the “R” content is 25.0 mass % or more, crystals in main phases of the R-T-B based permanent magnet, i.e., crystals having the R₂T₁₄B type crystal structure, are sufficiently readily generated. Additionally, deposition of a-Fe or the like with soft magnetism is readily reduced, and deterioration of magnetic properties is readily prevented. When the “R” content is 35.0 mass % or less, Br of the R-T-B based permanent magnet tends to be improved.

The heavy rare earth element content is not limited. For example, the heavy rare earth element content may be 0.1 mass % or more and 5.0 mass % or less or may be 0.6 mass % or more and 2.1 mass % or less. Any heavy rare earth element or elements may be contained; however, the R-T-B based permanent magnet according to the present embodiment contains at least Tb. Heavy rare earth elements other than Tb may or may not be contained. When heavy rare earth elements other than Tb are contained, for example, Dy may be contained.

The Tb content is not limited. For example, the Tb content may be 0.1 mass % or more and 5.0 mass % or less or may be 0.6 mass % or more and 2.1 mass % or less. When the Tb content is high, Br is readily reduced. When the Tb content is low, Hcj is readily reduced.

The total content of heavy rare earth elements other than Tb may be 0 mass % or more and 0.1 mass % or less. With the total content of heavy rare earth elements other than Tb being 0.1 mass % or less, Br tends to be improved.

The light rare earth element content is not limited. Any light rare earth element or elements may be contained. For example, at least one selected from Nd and Pr may be contained, or Nd may be contained.

The total content of light rare earth elements other than Nd may be 0 mass % or more and 7.0 mass % or less or may be 0 mass % or more and 0.1 mass % or less. The total content of light rare earth elements other than Nd and Pr may be 0 mass % or more and 0.1 mass % or less.

The boron content of the R-T-B based permanent magnet is not limited. The boron content may be 0.50 mass % or more and 1.50 mass % or less or may be 0.85 mass % or more and 1.05 mass % or less. With the boron content being 0.50 mass % or more, Hcj tends to be improved. With the boron content being 1.50 mass % or less, Br tends to be improved.

The carbon content of the R-T-B based permanent magnet is not limited. For example, the carbon content may be 0 mass % or more and 0.10 mass % or less.

The Co content of the R-T-B based permanent magnet is not limited. The Co content may be 0 mass % or more and 4.00 mass % or less, 0 mass % or more and 0.50 mass % or less, or 0 mass % or more and 0.30 mass % or less. The higher the Co content, the higher the raw material costs tend to be. The lower the Co content, the lower the corrosion resistance tends to be.

As a metal element or elements other than the above elements, the R-T-B based permanent magnet according to the present embodiment may contain Ga, Cu, Al, and/or Zr. The content of each of these elements is not limited.

The Ga content of the R-T-B based permanent magnet may be 0 mass % or more and 0.15 mass % or less or may be 0 mass % or more and 0.10 mass % or less.

The Cu content of the R-T-B based permanent magnet may be 0 mass % or more and 0.50 mass % or less, 0 mass % or more and 0.20 mass % or less, or above 0 mass % and 0.05 mass % or less.

The Al content of the R-T-B based permanent magnet may be 0 mass % or more and 0.40 mass % or less or may be 0.25 mass % or more and 0.40 mass % or less.

The Zr content of the R-T-B based permanent magnet may be 0 mass % or more and 0.50 mass % or less or may be 0 mass % or more and 0.20 mass % or less.

The R-T-B based permanent magnet may contain oxygen and nitrogen besides the above elements.

The oxygen content of the R-T-B based permanent magnet may be 0 mass % or more and 0.10 mass % or less. The nitrogen content of the R-T-B based permanent magnet may be 0 mass % or more and 0.10 mass % or less.

The Fe content of the R-T-B based permanent magnet may substantially be a balance of the R-T-B based permanent magnet. Specifically, the total content of other elements, i.e., the total content of elements other than rare earth elements, Fe, Co, B, C, Ga, Cu, Al, Zr, O, and N, may be 1.0 mass % or less.

The other elements may include inevitable impurities, such as Mn, Ca, Cl, S, and F.

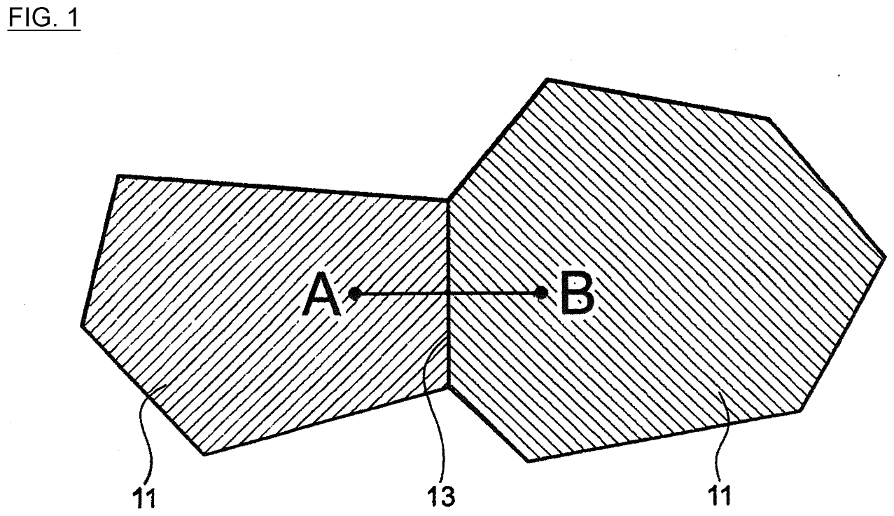

As shown in FIG. 1, the R-T-B based permanent magnet according to the present embodiment includes main phases 11 each having a core and a shell and a grain boundary phase 13 adjacent to the main phases 11. The shell contains Tb. The grain boundary phase 13 contains at least one selected from Fe and Co. The shell has a thickness of 70 nm or more. The shell has a Tb concentration with a maximum of 1.7 at % or more.

The grain boundary phase 13 may have a total concentration distribution of Fe and Co with a minimum of 65.0 at % or less. The grain boundary phase 13 may have a total concentration distribution of light rare earth elements with a maximum of 25.0 at % or more.

The grain boundary phase 13 may contain a transition metal element or elements other than Fe and Co. For example, Cu, Zr, Mn, or Ni may be contained. The ratio of the total concentration of Fe and Co of the grain boundary phase 13 to the total concentration of the transition metal elements of the grain boundary phase 13 may be 90% or more in terms of atomicity.

Having the above characteristics, the R-T-B based permanent magnet according to the present embodiment can have high Br, high Hcj, and high Hk/Hcj with relatively low usage of heavy rare earth elements.

The Tb concentration of the shell may gradually increase from the vicinity of the core to the vicinity of the grain boundary phase 13.

1.0≤[Tb_{b}]/[Tbₛ]≤1.5 may be satisfied, where [Tbₛ] (at %) is a maximum value of the Tb concentration of the shell and [Tb_{b}] (at %) is a maximum value of a Tb concentration of the grain boundary phase 13.

The Tb concentration of the core is not limited. For example, the Tb concentration of the core may be 0 at % or more and 2.0 at % or less. Preferably, the Tb concentration of the core is 0.3 at % or more and 1.0 at % or less. When the core contains 0.3 at % or more and 1.0 at % or less Tb, melting of the main phases 11 in a diffusion treatment in a high-temperature atmospheric-pressure atmosphere described later is prevented or reduced. Because melting of the main phases 11 is prevented or reduced, the shells of the main phases 11 do not thicken too much, and the shells readily have a high maximum value [Tbₛ] of the Tb concentration. With a high maximum value [Tbₛ] of the Tb concentration of the shells of the main phases 11, Hcj of the R-T-B based permanent magnet is readily increased.

Hereinafter, a method of distinguishing the core, the shell, and the grain boundary phase 13 of the R-T-B based permanent magnet according to the present embodiment and a method of measuring various parameters are described. The description is provided below on the premise that the grain boundary phase 13 contains at least one selected from Fe and Co as a transition metal element other than rare earth elements and contains only Tb and Nd as rare earth elements.

First, a measurement region of the R-T-B based permanent magnet is determined. A method of determining the measurement region is described later. At a location where the determined measurement region is included, the R-T-B based permanent magnet is cut to give a section.

Using the resulting section, the main phases 11 included in the measurement region and the grain boundary phase 13 adjacent to the main phases 11 are selected with a three-dimensional atom probe (3DAP).

Then, as shown in FIG. 1, a line AB that runs in two main phases 11 and one grain boundary phase 13 between the two main phases 11 and is substantially perpendicular to border lines between the main phases 11 and the grain boundary phase 13 is determined. Note that FIG. 1 is a schematic view illustrative of a method of determining the line AB, and the length of the line AB shown in FIG. 1 does not necessarily match the actual length of the line AB.

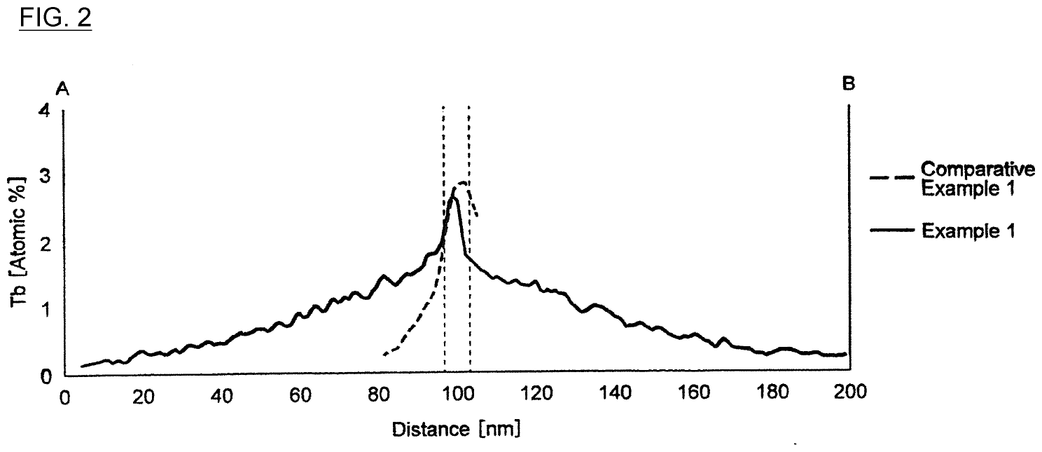

Then, a line analysis of the Tb concentration is performed along the line AB. FIG. 2 shows example results. FIG. 2 has a horizontal axis representing the distance from point A and a vertical axis representing the Tb concentration.

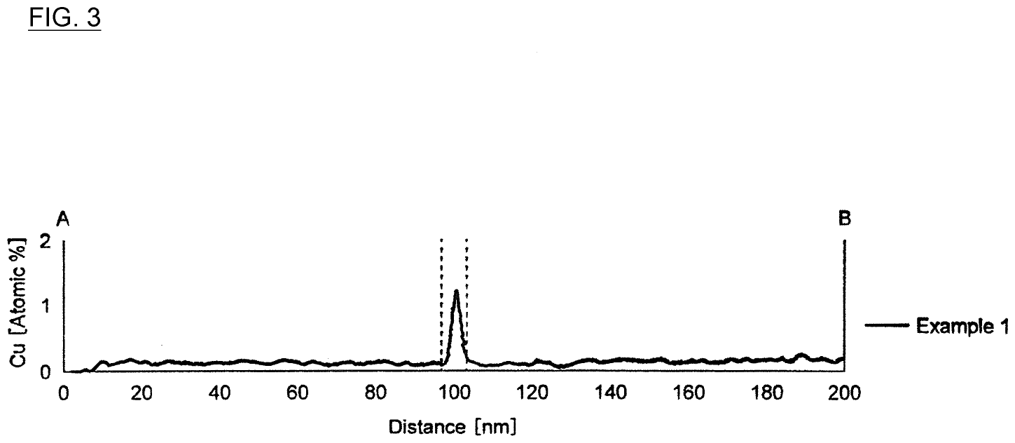

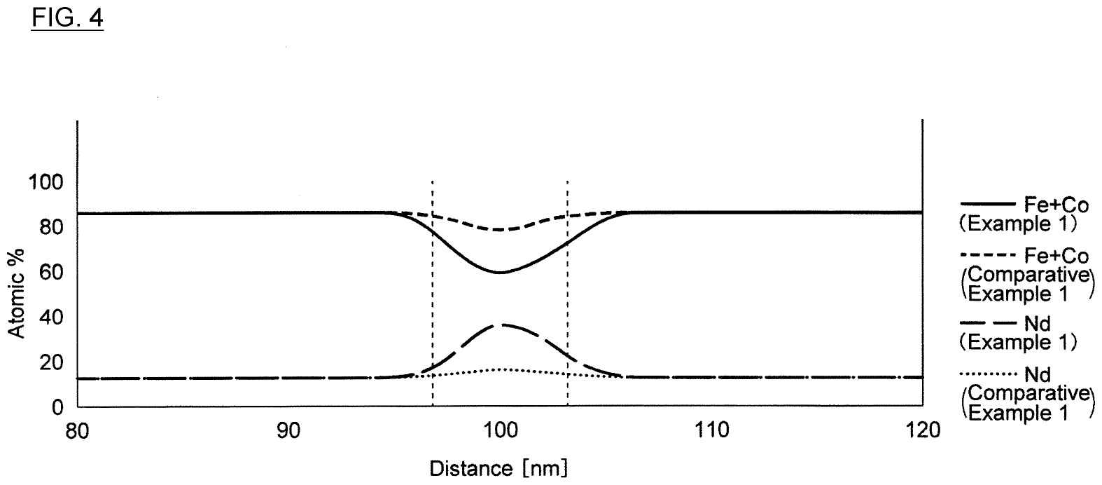

An element (Cu in FIG. 3) that is not readily contained relatively in the main phases 11, particularly in the shells, and is readily contained relatively in the grain boundary phase 13 is selected to perform a line analysis of the concentration with Tb along the line AB. FIG. 3 shows example results. Similarly to FIG. 2, FIG. 3 has a horizontal axis representing the distance from the point A and a vertical axis representing the concentration of the element. Further, line analyses of the Fe concentration, the Co concentration, and the light rare earth element concentration (Nd concentration) are performed along the line AB. FIG. 4 shows example results. FIG. 4 shows the concentrations of the elements of the grain boundary phase 13 and its vicinity.

Using FIG. 3, borders between the shells and the grain boundary phase 13 may be visually determined. According to FIG. 3, the Cu concentration rapidly decreases from the grain boundary phase 13 to the shells. Places where the Cu concentration becomes approximately constant are defined as the borders between the shells and the grain boundary phase 13. Broken lines in FIG. 3 show the places of the borders determined using FIG. 3. FIG. 2 is deemed to have borders at the same locations as FIG. 3.

The borders between the shells and the grain boundary phase 13 are determined from Cu concentration variation using FIG. 3. However, the borders between the shells and the grain boundary phase 13 may be determined from an element other than Cu or may be determined through observation of items other than concentration variation of the elements.

According to FIG. 2, the Tb concentration decreases from the borders between the shells and the grain boundary phase 13 to the inside of the main phases and becomes approximately constant at locations sufficiently apart from the borders. The locations where the Tb concentration is approximately constant are the cores. Locations where the Tb concentration decreases from the borders to the main phases are the shells. Whether the Tb concentration of the shells gradually increases from the vicinity of the cores to the vicinity of the grain boundary phase 13 is visually determined from the results of measuring the Tb concentration. In FIG. 2, the Tb concentration of the shells gradually increases from the vicinity of the cores to the vicinity of the grain boundary phase 13. Borders between the cores and the shells are visually determined from FIG. 2.

The borders between the shells and the grain boundary phase 13 may be determined so that the grain boundary phase 13 always has a Cu concentration of 0.15 at % or more and that portions of the shells in contact with the grain boundary phase 13 have a Cu concentration of less than 0.15 at %.

A portion that is included in each core and is apart from the border between the core and the shell by 100 nm or more may be defined as the inside of the core. The Tb concentration of the inside of the core prior to a diffusion treatment described later is substantially equivalent to the Tb concentration of a base material prior to the diffusion treatment. Because it is difficult to diffuse Tb to the inside of the core through a diffusion treatment step, the Tb concentration of the inside of the core after the diffusion treatment is also substantially equivalent to the Tb concentration of the base material prior to the diffusion treatment. Inside the core, the Tb concentration is approximately constant. The Tb concentration of the inside of the core can be measured using 3DAP, EPMA, or the like. The border between the core and the shell may be determined so that a portion having a Tb concentration higher than the Tb concentration of the inside of the core by 0.10 at % or more is defined as the shell.

A portion that is included in each shell and is apart by 1.0 nm or more from the grain boundary phase 13 in contact with the shell may be defined as the inside of the shell. Inside the shell, the Cu concentration is approximately constant.

Provided that measurement points of the Tb concentration are determined inside the shell at 10-nm intervals from the core to the grain boundary phase 13, the Tb concentration may be higher at the measurement points closer to the grain boundary phase 13. Further, differences in the Tb concentration between all the measurement points next to each other may be 0.01 at % or more and 0.50 at % or less. When the Tb concentration is higher at the measurement points closer to the grain boundary phase 13 and the differences in the Tb concentration between all the measurement points next to each other are 0.01 at % or more and 0.50 at % or less, the Tb concentration of the shell may gradually increase from the vicinity of the core to the vicinity of the grain boundary phase 13.

When 3DAP is used for measurement of the Tb concentration, temporary measurement points may be determined at 1-nm intervals to measure the Tb concentration. An average location of ten consecutive temporary measurement points may become one of the above measurement points, and the average Tb concentration of the ten consecutive temporary measurement points may be the Tb concentration of that measurement point. When the above method is used to determine the locations of the measurement points and measure the Tb concentration at these measurement points, influence of measurement noise is readily reduced, and errors in the differences in the Tb concentration between the measurement points next to each other do not readily occur.

When an element other than Cu (element that is readily contained relatively in the grain boundary phase 13) is used to determine the borders between the shells and the grain boundary phase 13, Cu may be replaced by the element other than Cu (element that is readily contained relatively in the grain boundary phase 13) in the above method of determining the borders.

Then, using the determined borders between the grain boundary phase 13 and the shells and the determined borders between the shells and the cores, the thickness of the shells of the main phases 11, the Tb concentration of the cores, the minimum value of the total concentration distribution of Fe and Co of the grain boundary phase 13, the maximum value of the Nd concentration distribution of the grain boundary phase 13, [Tbₛ], and [Tb_{b}] can be determined. Further, [Tb_{b}]/[Tbₛ] can be calculated.

Hereinafter, a method of determining a measurement region is described. The measurement region may be located at any portion of the R-T-B based permanent magnet. The measurement region may be located at a portion apart from a surface of the R-T-B based permanent magnet. For example, the measurement region may be a portion apart from a surface of the R-T-B based permanent magnet by 500 μm or more.

The main phases 11 having the above structures may occupy any percentage of the R-T-B based permanent magnet.

For example, the percentage of the main phases 11 having the above structures relative to the main phases 11 included in the R-T-B based permanent magnet may be 80% or more in terms of the number of main phases 11.

For example, the percentage of the main phases 11 having the above structures relative to the main phases 11 included in the portion apart from the surface of the R-T-B based permanent magnet by 500 μm or more may be 65% or more in terms of the number of main phases 11.

For example, several measurement sites may be determined at regular intervals on a line drawn from a centroid of the surface of the R-T-B based permanent magnet to a centroid of the R-T-B based permanent magnet, and whether the main phases 11 at the respective measurement sites have the above structures may be checked. The percentage of the main phases 11 having the above structures in each measurement site may be 80% or more in terms of the number of main phases 11.

For example, the percentage of the main phases 11 having the above structures relative to the main phases 11 included in a centroid portion of the R-T-B based permanent magnet may be 55% or more in terms of the number of main phases 11. The centroid portion is a portion having a shape similar to that of the R-T-B based permanent magnet, having a centroid at the same location as the R-T-B based permanent magnet, and having a volume of about 10% (e.g., 5% or more and 15% or less) of the R-T-B based permanent magnet.

### <Method of Manufacturing R-T-B Permanent Magnet>

Hereinafter, a method of manufacturing the R-T-B based permanent magnet is described in detail. Any known method may be used unless otherwise specified.

### [Raw Material Powder Preparation Step]

A raw material powder can be prepared using a known method. In the present embodiment, the R-T-B based permanent magnet is manufactured with a one-alloy method using one type of raw material alloy mainly including R₂T₁₄B phases; however, a two-alloy method using two types of raw material alloys may be used to manufacture the R-T-B based permanent magnet.

First, raw material metals corresponding to the composition of a raw material alloy according to the present embodiment are prepared, and the raw material alloy corresponding to the present embodiment is manufactured using the raw material metals.

Any method of manufacturing the raw material alloy may be used. For example, a strip casting method can be used to manufacture the raw material alloy.

The higher the Tb content of the raw material alloy (the raw material alloy that mainly becomes the main phases if the two-alloy method is used), the less readily the Tb concentration of the grain boundary phase becomes higher than the Tb concentration of the main phases in grain boundary diffusion described later.

When the Tb content of the raw material alloy is high, melting of the main phases by a diffusing material is prevented or reduced, and diffusion of Tb from the grain boundary phase to the main phases is prevented or reduced.

Prevention or reduction of melting of the main phases by the diffusing material prevents or reduces extreme melting of the main phases near a diffusion surface. Prevention or reduction of extreme melting of the main phases near the diffusion surface allows Tb to be diffused to the center of the magnet.

Prevention or reduction of diffusion of Tb from the grain boundary phase to the main phases readily reduces [Tb_{b}]/[Tbₛ].

After the raw material alloy is manufactured, the raw material alloy is pulverized (pulverization step). The pulverization step may be carried out in two stages or in one stage. Any pulverization method may be used. For example, various pulverizers may be used for pulverization. For example, the pulverization step can be carried out in two stages, which are coarse pulverization and fine pulverization. A hydrogen pulverization treatment can be carried out as coarse pulverization. Specifically, hydrogen can be stored in the raw material alloy at room temperature, then dehydrogenation can be carried out in an Ar gas atmosphere at 400° C. or more and 650° C. or less for 0.5 hours or more and 2 hours or less. Fine pulverization can be carried out using a jet mill, a wet attritor, or the like after a lubricant (e.g., oleic amide or zinc stearate) is added as a pulverization aid to the coarsely pulverized powder. The resulting finely pulverized powder (raw material powder) may have any particle size. For example, fine pulverization can be carried out so that the finely pulverized powder (raw material powder) has a particle size (D50) of 1 μm or more and 10 μm or less. From hydrogen storage pulverization to a sintering step described later, a low-oxygen atmosphere having an oxygen concentration of less than 200 ppm may always be used.

### [Pressing Step]

In a pressing step, the finely pulverized powder (raw material powder) resulting from the pulverization step is pressed into a predetermined shape. Any pressing method may be used. In the present embodiment, a mold is filled with the finely pulverized powder (raw material powder), and pressure is applied thereto in a magnetic field.

The pressure applied during pressing is preferably 30 MPa or more and 300 MPa or less. The magnetic field applied is preferably 950 kA/m or more and 1600 kA/m or less. The magnetic field applied is not limited to a static magnetic field and can also be a pulsed magnetic field. Also, a static magnetic field and a pulsed magnetic field can be used together. A green compact resulting from pressing the finely pulverized powder (raw material powder) may have any shape. The green compact can have any shape according to a desired shape of the R-T-B based permanent magnet, such as a rectangular parallelepiped shape, a plate shape, or a columnar shape.

### [Sintering Step]

The sintering step is a step of sintering the green compact in a vacuum or an inert gas atmosphere to give a sintered body. The sintering temperature needs to be adjusted according to conditions (e.g., composition, pulverization method, particle size, and particle size distribution). For example, the green compact is sintered through a heating treatment in a vacuum or under the presence of an inert gas at 1000° C. or more and 1200° C. or less for 1 hour or more and 10 hours or less. This gives the sintered body (permanent magnet) having a high density.

### [Aging Treatment Step]

An aging treatment step is carried out by heating the sintered body (permanent magnet) at a temperature lower than the sintering temperature in a vacuum or an inert gas atmosphere after the sintering step. The aging treatment temperature and the aging treatment time are not limited. The aging treatment step can be carried out, for example, at 450° C. or more and 900° C. or less for 0.2 hours or more and 3 hours or less. The aging treatment step may be omitted.

The aging treatment step may be carried out in one stage or in two stages. When the aging treatment step is carried out in two stages, a first stage may be heating at 700° C. or more and 900° C. or less for 0.2 hours or more and 3 hours or less, and a second stage may be heating at 450° C. or more and 700° C. or less for 0.2 hours or more and 3 hours or less. The first stage and the second stage may be carried out continuously. The sintered body may once be cooled to near room temperature after the first stage and may then be heated again in the second stage.

### [Machining Step (Prior to Grain Boundary Diffusion)]

As necessary, a step of machining the sintered body according to the present embodiment into a desired shape may be employed. Examples of machining methods include shape machining (e.g., cutting or grinding) and chamfering (e.g., barrel polishing).

### [Diffusion Treatment Step]

In the present embodiment, a diffusion treatment step of diffusing Tb is further included. A diffusion treatment can be carried out through a heat treatment after a Tb compound or the like is adhered to at least one surface of the sintered body. The Tb compound may of any type. For example, a Tb hydride may be mentioned. Any method of adhering the Tb compound may be used. For example, for the compound to adhere, a slurry containing Tb can be applied. By the amount of the applied slurry and the Tb concentration of the slurry, the thickness of the shells and the Tb concentration of the shells can be controlled. Note that the Tb concentration of the cores does not substantially change after the diffusion treatment step.

Any method of making Tb adhere may be used. Example methods include vapor deposition, sputtering, electrodeposition, spray coating, brush coating, a jet dispenser, a nozzle, screen printing, squeeze printing, and a sheet method.

When the slurry is applied, the Tb compound is preferably particulate. Further, the average particle size is preferably 100 nm or more and 50 μm or less or is more preferably 1 μm or more and 30 μm or less.

As a solvent used for the slurry, a solvent capable of uniformly dispersing the Tb compound without dissolving the compound is preferred. For example, alcohols, aldehydes, or ketones may be mentioned; and among these, ethanol is preferred.

In the slurry, the content of the Tb compound is not limited. For example, the content may be 50 mass % or more and 90 mass % or less. The slurry may further contain components other than Tb as necessary. For example, a dispersant or the like for preventing agglomeration of Tb particles may be mentioned.

Through the above diffusion treatment step for the sintered body, Tb diffuses to the grain boundaries of the sintered body in its entirety. Moreover, the shells having a high Tb concentration are formed in the main phases, and the main phases each having the core and the shell are provided.

In the present embodiment, the diffusion treatment step is carried out in multiple stages. Specifically, the diffusion treatment step is carried out through repetition of a diffusion treatment in a low-temperature reduced-pressure atmosphere and a diffusion treatment in a high-temperature atmospheric-pressure atmosphere. First, the temperature is increased from room temperature to a diffusion treatment temperature for the low-temperature reduced-pressure atmosphere (i.e. a low diffusion treatment temperature). At the same time, the pressure of the atmosphere is reduced from atmospheric pressure to a diffusion treatment pressure for the low-temperature reduced-pressure atmosphere (i.e. a reduced diffusion treatment pressure). Then, the sintered body is held in the low-temperature reduced-pressure atmosphere for a predetermined amount of holding time.

The low diffusion treatment temperature may be, for example, 500° C. or more and 700° C. or less. The reduced diffusion treatment pressure may be, for example, 0.1 kPa or more and 20 kPa or less. The holding time in the low-temperature reduced-pressure atmosphere is not limited. For example, the holding time may be 3 hours or more and 9 hours or less.

Second, the temperature of the atmosphere is increased from the low diffusion treatment temperature to a diffusion treatment temperature for the high-temperature atmospheric-pressure atmosphere (i.e. a high diffusion treatment temperature). At the same time, the pressure of the atmosphere is increased from the reduced diffusion treatment pressure to a diffusion treatment pressure for the high-temperature atmospheric-pressure atmosphere (i.e. an atmospheric diffusion treatment pressure). Then, the sintered body is held in the high-temperature atmospheric-pressure atmosphere for a predetermined amount of holding time.

The high diffusion treatment temperature may be, for example, 750° C. or more and 1000° C. or less. The atmospheric diffusion treatment pressure may be, for example, 80 kPa or more and 120 kPa or less. The holding time in the high-temperature atmospheric-pressure atmosphere is not limited. For example, the holding time may be 3 hours or more and 9 hours or less.

In the diffusion treatment in the low-temperature reduced-pressure atmosphere, which is the first stage of the diffusion treatment step, melting of the grain boundaries and the diffusing material (e.g., the Tb compound) can be facilitated while melting of the main phases is prevented or reduced. Thus, in the first diffusion treatment in the low-temperature reduced-pressure atmosphere, Tb is not readily diffused inside the main phases in the vicinity of the at least one diffusion surface (the at least one surface to which the Tb compound has adhered) of the R-T-B based permanent magnet. As the Tb concentration of the grain boundary phases is differentiated between the grain boundary phases in the vicinity of the at least one diffusion surface of the R-T-B based permanent magnet and the grain boundary phases inside the R-T-B based permanent magnet, a driving force for Tb diffusion is generated. Thus, Tb is readily diffused from the grain boundary phases in the vicinity of the at least one diffusion surface of the R-T-B based permanent magnet to the grain boundary phases inside the R-T-B based permanent magnet.

In the diffusion treatment in the high-temperature atmospheric-pressure atmosphere, which is the second stage of the diffusion treatment step, melting of portions of the main phases particularly adjacent to the grain boundary phases progresses. Tb, which has diffused to the grain boundary phases of the entire R-T-B based permanent magnet in the diffusion treatment in the low-temperature reduced-pressure atmosphere, diffuses to the main phases adjacent to the grain boundary phases. Cooling then follows, at which the melted main phases are deposited again on surfaces of unmelted main phases. The portions that are deposited again at that time have a high Tb content.

Consequently, the above diffusion method allows Tb to be diffused particularly inside the R-T-B based permanent magnet more readily than a conventional diffusion method used for the diffusion treatment step. Further, inside the R-T-B based permanent magnet, the shells of the main phases can be thickened and can have a higher Tb concentration. Moreover, the difference in the Tb concentration of the main phases between surfaces of the R-T-B based permanent magnet and the inside thereof is readily reduced. Thus, the R-T-B based permanent magnet has high Br, high Hcj, and high Hk/Hcj.

It is assumed that reasons why Hcj in particular can be increased are that the high Tb concentration of the shells increases magnetic anisotropy of main phase peripheral portions, where magnetization reversal starts, and that the large thickness of the shells facilitates separation of magnetism between the adjacent main phases.

It is assumed that a reason why Hk/Hcj in particular can be increased to particularly 97.0% or more is that reduction of the difference in the Tb concentration of the main phases between the inside and the surfaces of the magnet reduces unevenness of magnetic properties of the magnet as a whole.

Subsequently, the diffusion treatment in the low-temperature reduced-pressure atmosphere and the diffusion treatment in the high-temperature atmospheric-pressure atmosphere may be repeated for multiple times. When the diffusion treatment in the low-temperature reduced-pressure atmosphere and the diffusion treatment in the high-temperature atmospheric-pressure atmosphere are repeated for multiple times, the diffusion treatment temperature, the diffusion treatment pressure, and/or the holding time may be changed as appropriate according to the number of repetition. Through repetition of the diffusion treatment in the low-temperature reduced-pressure atmosphere and the diffusion treatment in the high-temperature atmospheric-pressure atmosphere for multiple times, the Tb concentration of the shells of the main phases readily increases gradually from the vicinity of the cores of the main phases to the vicinity of the grain boundary phases adjacent to the main phases.

In the conventional diffusion method used in the diffusion treatment step, the diffusing material melts main phases near magnet surfaces in the vicinity of the diffusing material.

Thus, Tb excessively remains near the magnet surfaces in the vicinity of the diffusing material. Diffusion of Tb from the magnet surfaces in the vicinity of the diffusing material to a center portion of the magnet thereby stagnates. Because Tb is not readily diffused in grain boundary phases at the center portion of the magnet, diffusivity of Tb from the grain boundary phases to main phases at the center portion of the magnet is further reduced. Consequently, the grain boundary phases at the center portion of the magnet contain more Tb more readily than the main phases at the center portion of the magnet do, and [Tb_{b}]/[Tbₛ] readily exceeds 1.5. Thus, the magnet manufactured using the conventional diffusion method readily has a lower coercivity and a lower squareness than the R-T-B based permanent magnet according to the present embodiment.

Further, after the heat treatment of the diffusion treatment step, an aging treatment step may be carried out.

After the diffusion treatment step, the at least one surface (diffusion surface) to which Tb has adhered may be polished to remove a residue. Using the above method to diffuse Tb can relatively reduce Tb contained in the residue removed and can improve magnetic properties of the R-T-B based permanent magnet with efficient use of Tb, which is expensive.

Hereinabove, the preferred embodiment of the R-T-B based permanent magnet of the present invention is described. However, the R-T-B based permanent magnet of the present invention is not limited to the above embodiment. The R-T-B based permanent magnet of the present invention can be variously modified within the scope of the invention, and various combinations are possible within the scope of the invention.

Further, the R-T-B based permanent magnet according to the present embodiment can be cut or divided to give magnets, which can still be used.

Specifically, the R-T-B based permanent magnet according to the present embodiment is suitably used for a motor, a compressor, a magnetometer, a speaker, etc.

The R-T-B based permanent magnet according to the present embodiment may be used singly, or two or more such R-T-B based permanent magnets bonded as necessary may be used. Any bonding method may be used. For example, the R-T-B based permanent magnets may be bonded mechanically or may be bonded by resin molding.

Bonding the two or more R-T-B based permanent magnets enables easy manufacture of a large R-T-B based permanent magnet. A magnet including the two or more R-T-B based permanent magnets bonded together is preferably used in, for example, an IPM motor, a wind power generator, or a large motor, which require a particularly large R-T-B based permanent magnet.

### EXAMPLES

Hereinafter, the present invention is described based on further detailed examples, but the present invention is not limited to these examples.

### Step of Manufacturing Pre-Tb Diffusion Magnet

Nd, Tb, electrolytic iron, and a low-carbon ferroboron alloy were prepared as raw material metals. Further, Al, Cu, Co, and Zr were prepared in a form of a pure metal or an alloy with Fe.

From the raw material metals, a raw material alloy was produced using a strip casting method so that the composition of a pre-Tb diffusion (described later) magnet was as shown in Table 1. Note that “bal.” shown as the Fe content indicates that the Fe content was substantially a balance. In all Examples and Comparative Example, the total content of elements other than the elements shown in Table 1 was 1 mass % or less. The raw material alloy had a thickness of 0.2 mm to 0.6 mm.

As the elements other than the elements shown in Table 1, H, Si, Ca, La, Ce, Cr, or the like may be detected as inevitable impurities or the like. Si may mainly come from the ferroboron raw material and a crucible used at the time of melting the alloy. Ca, La, and Ce may come from a rare earth raw material. Cr may come from electrolytic iron.

Then, a hydrogen gas flowed for the raw material alloy at room temperature for 1 hour so that the raw material alloy stored hydrogen. Then, the atmosphere was changed to an Ar gas, and the raw material alloy was dehydrogenated at 450° C. for 1 hour. Through above treatment, the raw material alloy was hydrogen pulverized. Further, after cooling, the raw material alloy was made into a powder having a particle size of 400 μm or less using a sieve.

Then, to the raw material alloy powder having gone through hydrogen pulverization, 0.1 mass % lubricant (oleic amide) was added as a pulverization aid, and they were mixed.

Then, the raw material alloy powder was finely pulverized in a nitrogen stream using an impact plate type jet mill apparatus to give a fine powder (raw material powder) having an average particle size of about 4 μm. The average particle size means D50 measured by a laser diffraction type particle size analyzer.

The resulting fine powder was pressed in a magnetic field to produce a green compact. The applied magnetic field at this time was a static magnetic field of 1200 kA/m. The pressure applied during pressing was 120 MPa. The direction of magnetic field application and the direction of pressure application were orthogonal to each other. When the density of the green compact was measured at this time, all green compacts had a density within a range of 4.10 Mg/m³ or more and 4.25 Mg/m³ or less.

Then, the green compact was sintered to give the pre-Tb diffusion magnet. Sintering conditions are described below. The green compact was held at 1060° C. for 4 hours. The sintering atmosphere was a vacuum. The sintering density at this time was within a range of 7.50 Mg/m³ or more and 7.55 Mg/m³ or less. Then, a first aging treatment was carried out for 1 hour at a first aging temperature T1=900° C., and further a second aging treatment was carried out for 1 hour at a second aging temperature T2=500° C. in an Ar atmosphere under atmospheric pressure.

The composition of the resulting pre-diffusion permanent magnet was evaluated using an X-ray fluorescence analysis. The B content was evaluated by ICP. It was thereby confirmed that the composition of the pre-diffusion permanent magnet was substantially the same as the composition of the raw material alloy. Then, the following treatment was carried out for the pre-diffusion permanent magnet.

### Comparative Example 1

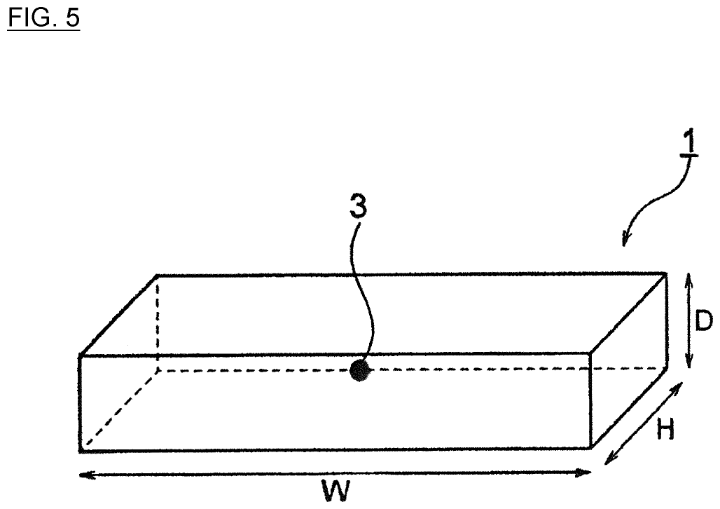

The pre-Tb diffusion magnet resulting from the above steps was machined so as to have a rectangular parallelepiped shape shown in FIG. 5. W=20 mm and H=10 mm were satisfied. D was determined so that a permanent magnet to be eventually obtained had a D length of 4 mm. The orientation direction was parallel to D. Then, to two 20 mm×10 mm surfaces of the pre-Tb diffusion magnet, a slurry having TbH₂ particles (D50=5 μm) dispersed in ethanol was applied to make Tb adhere. The amount of Tb adhesion in total relative to the mass of the pre-Tb diffusion magnet was as shown in Table 1.

After the slurry was applied, a heat treatment was carried out under a diffusion treatment pressure of atmospheric pressure (100 kPa) with Ar flowing at a diffusion treatment temperature of 850° C. for a holding time of 24 hours for Tb grain boundary diffusion. Further, in an Ar atmosphere at atmospheric pressure, an aging treatment was carried out at 500° C. for 1 hour.

Then, the two 20 mm×10 mm surfaces (diffusion surfaces) were scraped off by 500 μm in the D direction to give a permanent magnet (Tb diffused magnet) having a dimension of W=20 mm, H=10 mm, and D=4 mm (each sample).

The Tb content of the resulting permanent magnet was measured with an X-ray fluorescence (XRF) analysis apparatus. Table 1 shows the results.

Magnetic properties (Br, Hcj, and Hk/Hcj) of the resulting permanent magnet at a temperature RT (23° C.) were evaluated using a BH tracer. In the present experiment, Hcj was defined preferable at 2000 kA/m or more and more preferable at 2300 kA/m or more. Hk/Hcj was defined preferable at 97.0% or more.

Further, a three-dimensional atom distribution image of main phases 11 included in a measurement region (centroid 3) located 2.0 mm inwards in the D direction from centroids of the 20 mm×10 mm surfaces of the resulting R-T-B based permanent magnet 1 was obtained using 3DAP. It was confirmed that the main phases 11 each had a core and a shell. Then, a line AB that ran in the main phases 11 and a grain boundary phase 13 adjacent to the main phases was determined as shown in FIG. 1 using 3DAP, and line analyses of the Tb concentration, Cu concentration, Fe concentration, Co concentration, and Nd concentration on the line AB were performed to create graphs similar to FIGS. 2 to 4. From the shapes of the graphs, the Tb concentration of the core, the thickness of the shell, the minimum value of the total concentration distribution of Fe and Co of the grain boundary phase, the maximum value of the Nd concentration distribution of the grain boundary phase, [Tbₛ], and [Tb_{b}] were visually determined, and [Tb_{b}]/[Tbₛ] was calculated. Table 1 shows the results.

The broken lines of FIG. 2 are those corresponding to the grain boundary phase of Example 1 and are not those corresponding to the grain boundary phase of Comparative Example 1. However, the grain boundary phase of Comparative Example 1 was located near the location shown by the broken lines. Also, because Comparative Example 1 did not contain Co, concentration variation of Fe+Co of Comparative Example 1 shown in FIG. 4 was the same as concentration variation of Fe of Comparative Example 1.

### Examples 1 to 6

Examples 1 to 6 were carried out as in Comparative Example 1 except that a diffusion step was carried out in multiple stages. The diffusion step of Examples 1 to 6 was as follows.

After the slurry was applied, a diffusion treatment in a low-temperature reduced-pressure atmosphere was carried out. Specifically, a heating treatment was carried out under a diffusion treatment pressure of 1 kPa at a diffusion treatment temperature of 600° C. for a holding time of 6 hours with Ar flowing. Then, a diffusion treatment in a high-temperature atmospheric-pressure atmosphere was carried out. Specifically, the diffusion treatment pressure was increased to atmospheric pressure (100 kPa), and the diffusion treatment temperature was increased to 850° C. (870° C. in only Example 5), to carry out a heat treatment for a holding time of 6 hours. Then, another diffusion treatment in the low-temperature reduced-pressure atmosphere was carried out. Specifically, another heating treatment was carried out under a diffusion treatment pressure of 1 kPa at a diffusion treatment temperature of 600° C. for a holding time of 6 hours with Ar flowing. Then, another diffusion treatment in the high-temperature atmospheric-pressure atmosphere was carried out. Specifically, the diffusion treatment pressure was increased to atmospheric pressure (100 kPa), and the diffusion treatment temperature was increased to 850° C. (870° C. in only Example 5), to carry out another heat treatment for a holding time of 6 hours. Further, in an Ar atmosphere under atmospheric pressure, an aging treatment was carried out at 500° C. for 1 hour. Table 1 shows the results.

TABLE 1

| | | | | | | | | | | Diffusion |
|---|---|---|---|---|---|---|---|---|---|---|
| | Pre-Tb diffusion magnet | | | | | | | | Tb | step |
| | Composition | | | | | | | | adhesion | Whether |
| Sample | Nd | Tb | Co | Fe | B | Cu | Zr | Al | amount | in multiple |
| No. | mass % | mass % | mass % | mass % | mass % | mass % | mass % | mass % | mass % | stages |
| Comparative | 30.0 | 0.0 | 0.00 | bal. | 0.95 | 0.05 | 0.20 | 0.25 | 1.6 | No |
| Example 1 | | | | | | | | | | |
| Example 1 | 29.7 | 0.0 | 0.50 | bal. | 0.95 | 0.12 | 0.20 | 0.20 | 1.6 | Yes |
| Example 2 | 29.7 | 1.3 | 0.50 | bal. | 0.95 | 0.12 | 0.20 | 0.20 | 1.6 | Yes |
| Example 3 | 29.7 | 1.3 | 0.30 | bal. | 0.95 | 0.12 | 0.20 | 0.40 | 1.6 | Yes |
| Example 4 | 29.7 | 1.3 | 0.00 | bal. | 0.95 | 0.05 | 0.20 | 0.25 | 1.6 | Yes |
| Example 5 | 29.7 | 1.3 | 0.00 | bal. | 0.95 | 0.05 | 0.20 | 0.25 | 1.6 | Yes |
| Example 6 | 29.7 | 0.7 | 0.00 | bal. | 0.95 | 0.05 | 0.20 | 0.25 | 1.6 | Yes |

| | Tb diffused magnet | | | | | | | | | | |
|---|---|---|---|---|---|---|---|---|---|---|---|
| | | | | | Grain boundary phase | | | | Magnetic properties | | |
| | Composition | Core | Shell | | Fe + Co | Nd | | | Br | Hcj | Hk/ |
| Sample | Tb | Tb | Thickness | [Tbₛ] | min | max | [Tb_{b}] | [Tb_{b}]/ | (RT) | (RT) | Hcj |
| No. | mass % | at % | nm | at % | at % | at % | at % | [Tbₛ] | mT | kA/m | % |
| Comparative | 0.6 | 0.0 | 30 or less | 1.3 | 76.3 | 14.0 | 2.8 | 2.2 | 1438 | 1850 | 96.2 |
| Example 1 | | | | | | | | | | | |
| Example 1 | 0.6 | 0.0 | 90 or more | 1.7 | 57.1 | 33.4 | 2.5 | 1.5 | 1412 | 2050 | 97.2 |
| Example 2 | 2.0 | 0.5 | 70 or more | 2.1 | 60.1 | 30.6 | 2.9 | 1.4 | 1389 | 2310 | 97.1 |
| Example 3 | 2.0 | 0.5 | 80 or more | 2.3 | 64.8 | 26.5 | 3.0 | 1.3 | 1374 | 2390 | 97.4 |
| Example 4 | 2.1 | 0.5 | 90 or more | 2.5 | 59.1 | 31.5 | 3.0 | 1.2 | 1365 | 2560 | 97.8 |
| Example 5 | 2.1 | 0.6 | 90 or more | 2.6 | 63.9 | 26.9 | 3.5 | 1.3 | 1360 | 2600 | 98.3 |
| Example 6 | 1.3 | 0.3 | 90 or more | 2.6 | 62.1 | 28.3 | 3.4 | 1.3 | 1345 | 2650 | 98.3 |

According to Table 1, in each Example, in which the diffusion step was carried out in multiple stages, the shell had a thickness of 70 nm or more; [Tbₛ] was 1.7 at % or more; and the minimum value of the total concentration distribution of Fe and Co of the grain boundary phase was 65.0 at % or less. As a result, each Example had preferable Hcj and preferable Hk/Hcj. By contrast, in Comparative Example 1, in which the pre-Tb diffusion magnet did not contain Tb and the diffusion step was carried out not in multiple stages, the thickness of the shell and [Tbₛ] were too small, and Hcj and Hk/Hcj were low.

It was confirmed that, even when both conditions 1 and 2 below were satisfied, the results shown in Table 1 did not change.

Condition 1: A border between the shell and the grain boundary phase was determined so that the grain boundary phase always had a Cu concentration of 0.15 at % or more and that a portion of the shell in contact with the grain boundary phase had a Cu concentration of less than 0.15 at %.

Condition 2: A border between the core and the shell was determined so that a portion having a Tb concentration higher than the Tb concentration of the inside of the core by 0.10 at % or more was defined as the shell.

At this time, calculation was performed on the premise that the Tb concentration of the inside of the core was equivalent to the Tb concentration of the pre-Tb diffusion magnet.

It was confirmed that, in all Examples, when measurement points of the Tb concentration were determined inside the shell at 10-nm intervals from the core to the grain boundary phase 13, the Tb concentration was higher at the measurement points closer to the grain boundary phase 13, and differences in the Tb concentration between all the measurement points next to each other were 0.01 at % or more and 0.50 at % or less. That is, it was confirmed that, in all Examples, the Tb concentration of the shell gradually increased from the vicinity of the core to the vicinity of the grain boundary phase.

By contrast, it was confirmed that, in Comparative Example 1, when measurement points of the Tb concentration were determined inside the shell at 10-nm intervals from the core to the grain boundary phase 13, differences in the Tb concentration between the measurement points next to each other may have been about 1 at %. That is, it was confirmed that, in Comparative Example 1, the Tb concentration of the shell did not gradually increase from the vicinity of the core to the vicinity of the grain boundary phase.

### REFERENCE NUMERALS

1 . . . R-T-B based permanent magnet
3 . . . centroid
11 . . . main phase
13 . . . grain boundary phase

What is claimed is:

1. An R-T-B based permanent magnet comprising:
main phases each comprising a core and a shell; and
a grain boundary phase adjacent to the main phases,
wherein
the shell comprises Tb;
the shell has a thickness of 70 nm or more; and
the shell has a Tb concentration with a maximum of 1.7 at % or more.

2. The R-T-B based permanent magnet according to claim 1, wherein the Tb concentration of the shell gradually increases from a vicinity of the core to a vicinity of the grain boundary phase.

3. The R-T-B based permanent magnet according to claim 1, wherein,
provided that measurement points of the Tb concentration are determined inside the shell at 10-nm intervals from the core to the grain boundary phase,
the Tb concentration is higher at the measurement points closer to the grain boundary phase; and
differences in the Tb concentration between all the measurement points next to each other are 0.01 at % or more and 0.50 at % or less.

4. The R-T-B based permanent magnet according to claim 1 satisfying 1.0≤[Tb_{b}]/[Tbₛ]≤1.5, where [Tbₛ] is a maximum value of the Tb concentration of the shell and [Tb_{b}] is a maximum value of a Tb concentration of the grain boundary phase.

5. The R-T-B based permanent magnet according to claim 1 having a Tb content of 0.6 mass % or more and 2.1 mass % or less.

6. The R-T-B based permanent magnet according to claim 1 comprising Fe or both Fe and Co as a transition metal element.

7. The R-T-B based permanent magnet according to claim 1, wherein
the grain boundary phase comprises at least one selected from Fe and Co; and
the grain boundary phase has a total concentration distribution of Fe and Co with a minimum of 65.0 at % or less.

8. The R-T-B based permanent magnet according to claim 1 having a squareness Hk/Hcj of 97.0% or more.
